(19) United States
(12) Patent Application Publication
(10) Pub. No.: US 2017/0223988 A1
(43) Pub. Date: Aug. 10, 2017

(54) COATED FEED COMPOSITIONS AND METHODS OF MAKING AND USING THEREOF

(71) Applicant: BENEMILK OY, Raisio (FI)

(72) Inventors: Merja Birgitta HOLMA, Raisio (FI); Ilmo Pellervo ARONEN, Hinnerjoki (FI); Feng WAN, Issaquah, WA (US); Christopher John BUNTEL, Singapore (SG)

(73) Assignee: BENEMILK OY, Raisio (FI)

(21) Appl. No.: 15/500,719

(22) PCT Filed: Jul. 31, 2014
(86) PCT No.: PCT/US14/49047

§ 371 Date: Jan. 31, 2017

(51) Int. Cl. A23K 50/10; A23K 20/147; A23K 40/35; A23K 20/163; A23K 20/174; A23K 20/20; A23K 20/142; A23K 20/158

(52) U.S. Cl. CPC A23K 50/10; A23K 20/142; A23K 20/147; A23K 20/158; A23K 20/163; A23K 20/174; A23K 20/20; A23K 40/35

(57) ABSTRACT

Feed compositions, methods of preparing such compositions, and methods of feeding such compositions are described. A feed composition may include a core and a first coating layer disposed around at least a portion of the core. The core may include at least one carbohydrate component and at least one protein component. The first coating layer may include a fatty acid component having at least about 90% saturated fatty acid by weight.

### BACKGROUND

Increasing production and fat content of milk obtained from lactating ruminants has been a major goal for dairy farmers. Additional milk production per ruminant is beneficial because it results in a higher yield, thereby increasing profits. Increased milk fat is desirable because it has a higher economic value and can be used in highly desirable food products, such as cheese, yogurt, and the like.

Either or both of the milk production and milk fat content are commonly increased by adjusting feed, nutrients, elements, vitamins, supplements, and/or the like provided to the ruminant. One such specific method includes feeding the ruminant a total mixed ration (TMR), which is a mix of grain and silage with some protein meals, such as, for example, soya bean meal and canola meal. Additional materials and trace elements, vitamins, extra nutrients, and the like may also be added to the TMR.

However, the current methods and feeds used to increase milk fat content tend to lower milk production, lower protein content, and/or have other detrimental effects on the ruminant. Furthermore, current methods and feeds often result in other undesired effects, such as increased trans fatty acid levels on the fatty acid profile of the milk fat.

### SUMMARY

In an embodiment, a feed composition may include a core and a first coating layer disposed around at least a portion of the core. The core may include at least one carbohydrate component and at least one protein component. The first coating layer may include a fatty acid component having at least about 90% saturated fatty acid by weight.

In an embodiment, a method of preparing a feed composition may include combining at least one carbohydrate component and at least one protein component to obtain a core material and disposing a first coating layer around at least a portion of the core material to obtain a coated core. The first coating layer may include a fatty acid component having at least about 90% saturated fatty acid by weight.

In an embodiment, a method of increasing milk fat content in ruminants may include providing a feed composition to a ruminant for ingestion. The feed composition may include a core including at least one carbohydrate component and at least one protein component. The teed composition may also include a first coating layer disposed around at least a portion of the core. The first coating layer ay include a fatty acid component comprising at least about 90% saturated fatty acid by weight.

### BRIEF DESCRIPTION OF THE DRAWINGS

FIG. 1 depicts a cross-sectional view of an illustrative feed particle according to an embodiment.

FIG. 2 depicts a cross-sectional view of an illustrative feed particle according to another embodiment.

FIG. 3 depicts a flow diagram of an illustrative method of preparing a core portion of a feed composition according to an embodiment.

FIG. 4 depicts a flow diagram of an illustrative method of preparing one or more coating materials and coating a core portion of a feed composition according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

A ruminant is a class of mammal with a multiple chamber stomach that gives the animal an ability to digest cellulose-based food. The stomach of a ruminant has four morphologically distinct compartments: the rumen, the reticulum, the omasum, and the abomasum. Bacteria in the rumen enable the ruminant to digest cellulose-based food by softening it and regurgitating the semi-digested mass. The regurgitate, known as cud, is then chewed again by the ruminant. Specific examples of ruminants include, but are not limited to, cattle, bison, buffaloes, yaks, camels, llamas, giraffes, deer, pronghorns, antelopes, sheep, and goats. The milk produced by ruminants is widely used in a variety of dairy-based products. Dairy cows are of considerable commercial significance for the production of milk and processed dairy products such as, for example, yogurt, cheese, whey, and ice cream.

Silage refers to a feed that includes chopped green forage, such as, for example, grass, legumes, and field corn. The silage is placed in a structure or a container that is designed to exclude air. The silage is then fermented in the structure or container, thereby retarding spoilage. Silage can have a water content of about 60% to about 80% by weight.

The present disclosure relates generally to feed compositions that can be fed to ruminants to affect milk produced by ruminants. Particularly, the feed compositions described herein may be fed to a ruminant to increase the amount of milk produced by the ruminant and/or to increase the fat content of the milk produced by the ruminant, as described in greater detail herein.

When a ruminant consumes feed, the rumen modifies the fat in the feed to provide a milk fat profile that is different from the feed fat profile. All fats which are not completely inert in the rumen may decrease rumen digestibility of the feed material. Milk composition and fat quality can be influenced by the ruminant's diet. For example, oil feeding can have negative effects on both rumen function and milk formation. As a result of oil feeding, milk protein concentration is lowered, fat concentration is decreased, and the proportion of trans fatty acids is increased in ruminants. These effects have been connected to an increase in harmful low-density lipoprotein (LDL) cholesterol and to a decrease in beneficial high-density lipoprotein (HDL) cholesterol in human blood when the milk is consumed. In addition, the properties of the milk fat during industrial milk processing are weakened. A high level of polyunsaturated fatty acids in milk can also cause taste detects and preservation problems. A typical fatty acid composition of milk fat for ruminants feed conventional feeds may contain more than. 70% saturated fatty acids, and the total amount of trans fatty acids in such milk may vary in a range of 3%-10%. When vegetable oil is added into the feed, the proportion of trans fatty acids may rise to more than 10%.

One solution to diminishing the detrimental effect of oil and fat is to prevent triglyceride fat hydrolysis. Fat hydrolysis can be decreased, for example, by protecting fats with formaldehyde treated casein. Another alternative is to make insoluble fatty acid calcium salts whereby hydrogenation in the rumen can be avoided. However, fatty acid salts have a pungent taste, which can limit their usability in feeds and can result in decreased feed intake. The salts may also impact an ability to pelletize the feed.

Accordingly, the feed compositions described herein allow for the transfer of palmitic acid from the feed via the digestive tract into the blood circulation of a ruminant. This improves the energy efficiency of milk production of the ruminant. When the utilization of energy becomes more efficient, the milk production increases and the concentrations of protein and fat in the milk rise. In particular, the feed composition enhances fat synthesis in the mammary gland by bringing milk fat components to the cell. As a result, the energy-consuming fat synthesis in the mammary gland may not be necessary. Thus, glucose may be more efficiently used for lactose production whereupon milk production increases. In addition, milk protein content rises because glucose need not be produced from amino acids. As a result, the ruminant may not lose as much weight at the beginning of the lactation period as compared to a ruminant not provided with a feed composition of a type described herein.

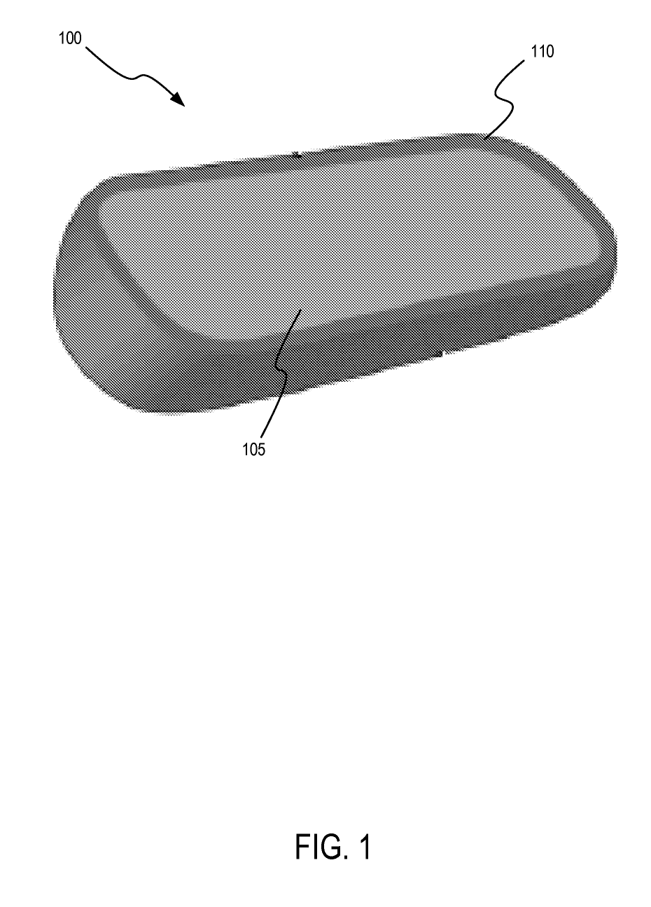

FIG. 1 depicts a cross-sectional view of an illustrative feed particle, generally designated 100 according to an embodiment. The feed particle 100 may be a portion of a feed composition. For example, the feed composition may include a plurality of feed particles. Thus, the terms “feed composition” and “feed particle”, as used herein, may generally be used interchangeably, except where specifically described otherwise.

In various embodiments, the feed particle 100 may include at least a core 105 and a coating layer 110. The feed particle 100 may generally be arranged such that the coating layer 110 covers at least a portion of the core 105. Thus, the coating layer 110 may be disposed around at least a portion of the core 105. For example, the coating layer 110 may be disposed around a portion of the surface area of the core 105, such as about 1%, about 10%, about 20%, about 30%, about 40%, about 50%, about 60%, about 70%, about 80%, about 90%, about 100% of the surface area of the core, or any value or range between any two of these values (including endpoints). In some embodiments, the coating layer 110 may completely encapsulate the core 105. In some embodiments, the coating layer 110 may be intermittently dispersed about the surface area of the core.

In various embodiments, the core 105 may be a solid material that has been formed into particles, as described in greater detail herein. The core 105 may generally be any shape and or size, particularly shapes and/or sizes that are suitable for the preparation methods described herein and/or that are suitable for ruminant consumption. For example, certain ruminants may prefer a particular shape and/or size any may not consume the feed composition unless it is a particular shape and/or size. The core 105 may also be formed such that it has a particular consistency so as to remain intact during various forming, processing, transporting, and/or handling steps, as described in greater detail herein.

The core 105 may generally include a plurality of ingredients. For example, in some embodiments, the core 105 may include at least one carbohydrate component and at least one protein component. The at least one carbohydrate component is not limited by this disclosure and may generally be any carbohydrate, carbohydrate-containing ingredient, or ingredient derived from a carbohydrate source. Illustrative carbohydrates include, but are not limited to, molasses, sugar beet pulp, sugar cane, wheat bran, wheat middlings, wheat mill run, oat hulls, grain hulls, soya hulls, soybean hulls, peanut hulls, wood, brewery byproducts, beverage industry byproducts, forages, roughages, bean meal, grass meal, hay meal, hay, straw, rapeseed meal, alfalfa meal, alfalfa, straw, silages, sugars, starches, cellulose, hemicellulose, wheat, corn, oats, sorghum, millet, barley, barley fiber, barley hulls, barley middlings, barley bran, malting barley screenings, malting barley and fines, malt rootlets, maize bran, maize middlings, maize cobs, maize screenings, maize fiber, millet, rice, rice bran, rice middlings, rye, triticale, brewers grain, coffee grinds, tea leaf fines, citrus fruit pulp, rind residues, algae, algae meal, microalgae, and/or the like.

The carbohydrate component may be obtained from any carbohydrate source, and thus the source is not limited by this disclosure. In some embodiments, the carbohydrate may be obtained by breaking down a complex sugar source. Illustrative carbohydrate sources may include sugar, starch, cellulose, hemicellulose, and/or the like. In some embodiments, the carbohydrate may be obtained from various crops that contain carbohydrates. Illustrative crops may include wheat, corn, oats, sorghum, millet, barley, and/or the like.

The at least one protein component is not limited by this disclosure and may generally include any protein, any ingredient that contains protein, or any ingredient that is derived from a protein source. Illustrative protein sources include, but are not limited to, soybean, canola seed, cottonseed, corn gluten meal, and any combination thereof. Other illustrative protein sources may include, but are not limited to, palm oil, meat meal, poultry meal, blood meal, feather meal, fish meal, wheat middlings, soybean hulls, corn byproducts, torula yeast, brewer's yeast, and any combination thereof. In some embodiments, the protein component may include oilseed meal. Oilseed meal is generally derived from residue that remains after reserved oil is removed from oilseeds. The oilseed meal may be rich in protein and variable in residual fats and oils. Illustrative examples of oilseed meal include soy meal, bean meal, rapeseed meal, soybean meal, sunflower meal, coconut meal, olive meal, linseed meal, grapeseed meal, cottonseed meal, camelina meal, mustard seed meal, crambe seed meal, safflower meal, rice meal, peanut meal, corn gluten meal, corn gluten feed, distillers dried grains, distillers dried grains with solubles, wheat gluten, and/or the like.

In addition to the at least one carbohydrate component and the at least one protein component, the core 105 may also include one or more additional ingredients. Additional ingredients may generally provide a nutritional benefit to the ruminant consuming the feed particle 100 and/or may make the feed particle more palatable or desirable to the ruminant. Illustrative additional ingredients include, but are not limited to, vitamins, minerals, carnitine, and/or the like.

Illustrative vitamins may include, but are not limited to, vitamin A, vitamin B, vitamin C, vitamin D, vitamin E, vitamin K, and/or the like, as well as any combination thereof. In some embodiments, a vitamin may include any vitamins from each particular vitamin group, including A vitamins, B vitamins, C vitamins, D vitamins, E vitamins, K vitamins, and/or the like. Specific examples of B vitamins include thiamine (vitamin B₁), riboflavin (vitamin B₂), niacin (vitamin B₃), pantothenic acid (vitamin B₅), pyridoxine (vitamin B₆), biotin (vitamin B₇), folic acid (vitamin B₉), cobalamin (vitamin B₁₂), and choline (vitamin Bₚ),

Illustrative minerals may be generally recognized as safe (GRAS) minerals or a combination of such minerals. A mineral may further be obtained from any mineral source that provides a. bioavailahle mineral. In some embodiments, a mineral may be one or more of calcium, sodium, magnesium, potassium, phosphorous, zinc, selenium, manganese, iron, cobalt, copper, iodine, molybdenum, and/or the like. In some embodiments, a mineral may be selected from one or more of a sodium salt, a calcium salt, a magnesium salt, a cobalt salt, a manganese salt, a potassium salt, an iron salt, a zinc salt, copper sulfate, copper oxide, selenium yeast, a chelated mineral, and/or the like. illustrative sodium salts include, but are not limited to, monosodium phosphate, sodium acetate, sodium chloride, sodium bicarbonate, disodium phosphate, sodium iodate, sodium iodide, sodium tripolyphosphate, sodium sulfate, sodium selenite, and/or the like. Illustrative calcium salts include, but are not limited to, calcium acetate, calcium carbonate, calcium chloride, calcium gluconate, calcium hydroxide, calcium iodate, calcium iodobehenate, calcium oxide, anhydrous calcium sulfate, calcium sulfate dehydrate, dicalcium phosphate, monocalciutm phosphate, tricalcium phosphate, and/or the like. Illustrative magnesium salts include, but are not limited to, magnesium acetate, magnesium carbonate, magnesium oxide, magnesium sulfate, and/or the like. Illustrative cobalt salts include, but are not limited to, cobalt acetate, cobalt carbonate, cobalt chloride, cobalt oxide, cobalt sulfate, and/or the like. Illustrative manganese salts include, but are not limited to, manganese carbonate, manganese chloride, manganese citrate, manganese gluconate, manganese orthophosphate, manganese oxide, manganese phosphate, manganese sulfate, and/or the like. Illustrative potassium salts include, but are not limited to, potassium acetate, potassium bicarbonate, potassium carbonate, potassium chloride, potassium iodate, potassium iodide, potassium sulfate, and/or the like. Illustrative iron salts include, but are not limited to, iron ammonium citrate, iron carbonate, iron chloride, iron gluconate, iron oxide, iron phosphate, iron pyrophosphate, iron sulfate, reduced iron, and/or the like. Illustrative zinc salts include, but are not limited to, zinc acetate, zinc carbonate, zinc chloride, zinc oxide, zinc sulfate, and/or the like.

Carnitine is a quaternary ammonium compound biosynthesized from the amino acids lysine and methionine. In various embodiments, carnitine may be included in the core 105 to aid in the breakdown of fatty acids to generate metabolic energy in the ruminant. In some embodiments, carnitine may be added to the core 105 from a camitine premix composition.

In various embodiments, the coating layer 110 may generally include a fatty acid component. In particular embodiments, the coating layer 110 may consist essentially of the fatty acid component. In other particular embodiments, the coating layer 110 may consist of the fatty acid component, thus containing no additional ingredients. In other embodiments, the coating layer 110 may include the fatty acid component and one or more additional ingredients, as described in greater detail herein.

The fatty acid component may be present in generally any concentration, particularly at least about 10% of the feed particle 100. For example, the fatty acid component may be about 10% to about 90% by weight of the feed particle 100. In further examples, the fatty acid component may be present in the feed particle 100 in an amount of about 30% to about 50%, about 40% to about 60%, or about 60% to about 90% by weight of the feed particle. Specific examples of amounts by weight of the feed particle 100 include about 10%, about 20%, about 30%, about 40%, about 50%, about 60%, about 70%, about 80%, about 90%, or any value or range between any two of these values (including endpoints).

In various embodiments, the fatty acid component may generally include one or more free fatty acids and/or glycolipids. Free fatty acids may generally be unconjugated fatty acids, whereas glycolipids may be acids conjugated with a carbohydrate. In sonic embodiments, the fatty acid component may be present in the coating layer 110 in an amount of at least about 30% by weight of the coating layer. For example, the fatty acid component may be present in the coating layer 110 in an amount of about 10% by weight to about 90% by weight or more of the coating layer. In some embodiments, the fatty acid component may be present in the coating layer 110 in an amount of at least about 50% by weight of the coating layer. in particular embodiments, the fatty acid component may be present in the coating layer 110 in an amount of about 10% by weight, about 15% by weight, about 20% by weight, about 25% by weight, about 30% by weight, about 35% by weight, about 40% by weight, about 45% by weight, about 50% by weight, about 55% by weight, about 60% by weight, about 65% by weight, about 70% by weight, about 75% by weight, about 80% by weight, about 85% by weight, about 90% by weight, or any value or range between any two of these values (including endpoints). In embodiments, the fatty acid component may be present in the coating layer 110 in a range within about 30% to about 50%, about 30% to about 90%, or about 40% to about 60% by weight of the coating layer.

In some embodiments, the fatty acid component may have a melting point greater than or equal to about 40° C. In some embodiments, the fatty acid component may have a melting point less than or equal to about 80° C. In some embodiments, the fatty acid component may have a melting point of about 40° C. to about 80° C. In some embodiments, the fatty acid component may have a melting point of about 60° C. to about 80° C. In some embodiments, the fatty acid component may have a melting point of about 63° C. to about 65° C. In particular embodiments, the fatty acid component may have a melting point of about 40° C., about 45° C., about 50° C., about 55° C., about 60° C., about 65° C., about 70° C., about 75° C., about 80° C., or any value or range between any two of these values (including endpoints). In some embodiments, the melting point of the fatty acid component may be greater than the temperature of the rumen to ensure that the fatty acid is inert in the rumen environment.

In various embodiments, the fatty acid component may include at least one saturated fatty acid. For example, the fatty acid component may include 1, 2, 3, 4, 5, 6, or more different saturated fatty acids. In some embodiments, the saturated fatty acid may be present in the fatty acid component in an amount that results in a ruminant consuming the feed composition to produce a desired quality and quantity of milk, as described in greater detail herein. Thus, in some embodiments, the saturated fatty acid may be present in any amount, such as an amount of at least about 90% by weight of the fatty acid component. In some embodiments, the saturated fatty acid may be present in an amount of about 90% by weight of the fatty acid component to about 100% by weight of the fatty acid component, including about 90% by weight, about 91% by weight, about 92% by weight, about 93% by weight, about 94% by weight, about 95% by weight, about 96% by weight, about 97% by weight, about 98% by weight, about 99% by weight, about 100% by weight, or any value or range between any two of these values (including endpoints). The saturated fatty acid is not limited by this disclosure and may include any number of saturated fatty acids now known or later discovered, including all derivatives thereof. For example, derivatives of a saturated fatty acid may include salts, esters, amides, carbonates,carbamates, imides, anhydrides, alcohols, and/or the like.

As used herein, a salt of the fatty acid may be any acid addition salt, including, but not limited to, halogenic acid salts such as, for example, hydrobromic, hydrochloric, hydrofluoric, and hydroiodic acid salts; inorganic acid salts such as, for example, nitric, perchloric, sulfuric, and phosphoric acid salts; organic acid salts such as, for example, sulfonic acid salts (methanesulfonic, trifluoromethane sulfonic, ethanesulfonic, benzenesulfonic, or p-toluenesulfonic), acetic,malic, fumaric, succinic, citric, benzoic, gluconic, lactic, mandelic, mucic, pamoic, pantothenic, oxalic, and maleic acid salts; and amino acid salts such as aspartic or glutamic acid salts. The acid addition salt may be a mono- or di-acid addition salt, such as a di-hydrohalogenic, di-sulfuric, di-phosphoric, or di-organic acid salt. In all cases, the acid addition salt s used as an achiral reagent which is not selected on the basis of any expected or known preference for interaction with or precipitation of a specific optical isomer of the products of this disclosure.

A fatty acid ester, as used herein, means an ester of a fatty acid. For example, the fatty acid ester may be in a form of RCOOR′. R may be any saturated or unsaturated alkyl group including, without limitation, C10, C12, C14, C16, C18, C20, and C24. R′ may be any groups having from about 1 to about 1000 carbon atoms and with or without hetero atoms. In some embodiments. R′ may have from about 1 to about 20 carbon atoms, from about 3 to about 10 carbon atoms, or from about 5 to about 15 carbon atoms. The hetero atoms may include, without limitation, N, O, S, P, Se, halogen, Si, and B. For example, R′ may be a C₁₋₆alkyl, such as methyl, ethyl or t-butyl; a C₁₋₆alkoxyC₁₋₆alkyl; a heterocyclyl, such as tetrahydrofur a C₆₋₁₀araryloxyC₁₋₆alkyl, such as benzyloxymethyl (BOM); a silyl, such as trimethylsilyl, t-butyldimethylsilyl and t-butyldiphenylsilyl; a cinnamyl; an allyl; a C₁₋₆alkyl which is mono-, di- or trisubstituted by halogen, silyl, cyano or C₁₋₆aryl, wherein the aryl ring is unsubstituted or substituted by one, two, or three residues selected from the group consisting of C₁₋₇alkyl, C₁₋₇alkox, halogen, nitro, cyano and CF₃; or a C₁₋₂alkyl substituted by 9-fluorenyl.

As used herein, a fatty acid amide may generally include amides of fatty acids where the fatty acid is bonded to an amide group. For example, the fatty acid amide may have a formula of RCONR′R″. R may be any saturated or unsaturated alkyl group including, without limitation, C10, C12, C14, C16, C18, C20, and C24. R′ and R″ may each be any group having from about 1 to about 1000 carbon atoms and with or without hetero atoms. In some embodiments, R′ and. R′ may each have from about 1 to about 20 carbon atoms, from about 3 to about 10 carbon atoms, or from about 5 to about 15 carbon atoms. The hetero atoms may include, without limitation, N, O, S, P, Se, halogen, Si, and B. For example, R′ and R″ each may be an alkyl, an alkenyl, an alkynyl, an aryl, an aralkyl, a cycloalkyl, a halogenated alkyl, or a heterocycloalkyl group.

A fatty acid anhydride may generally refer to a compound which results from the condensation of a fatty acid with a carboxylic acid. Illustrative examples of carboxylic acids that may be used to form a fatty acid anhydride include acetic acid, propionic acid, benzoic acid, and the like.

An alcohol of a fatty acid refers to a fatty acid having a straight chain or branched, saturated radical groups. The fatty acid alcohol may additionally have 3-30 carbon atoms and one or more hydroxy groups. The alkyl portion of the alcohol component can be propyl, butyl, pentyl, hexyl, iso-propyl, iso-butyl, sec-butyl, tert-butyl, or the like. One of skill in the art may appreciate that other alcohol groups may also be useful in the present disclosure.

In some embodiments, the saturated fatty acid may include a palmitic acid compound. The palmitic acid compound is not limited by this disclosure, and may include one or more of a conjugated palmitic acid, unconjugated palmitic acid, free palmitic acid, palmitic acid derivatives, and/or the like. In some embodiments, the palmitic acid compound may include at least about 70% by weight free palmitic acid, including, but not limited to, about 70% by weight, about 75% by weight, about 85% by weight, about 85% by weight, about 90% by weight, about 95% by weight, about 100% by weight, or any value or range between any two of these values (including endpoints). Palmitic acid, also known as hexadecanoic acid, has a molecular formula of CH₃(CH₂)₁₄CO₂H. Specific examples of palmitic acid derivatives may include palmitic acid esters, palmitic acid amides, palmitic acid salts, palmitic acid phosphonates, palmitic acid sulfates, palmitic acid carbonates, palmitic acid carbamates, palmitic acid imides, palmitic acid anhydrides, palmitate triglycerides, pahnitate salts, and/or the like. The palmitic acid compound may be present in the fatty acid component in generally any amount, such as an amount of at least about 60% by weight of the fatty acid component, including, for example, about 60% by weight of the fatty acid to about 100% by weight of the fatty acid, including about 60% by weight, about 65% by weight, about 70% by weight, about 75% by weight, about 80% by weight, about 85% by weight, about 90% by weight, about 95% by weight, about 98% by weight, about 99% by weight, about 100% by weight, or any value or range between any two of these values (including endpoints). In some embodiments, the fatty acid component may consist essentially of the palmitic acid compound. In other embodiments, the fatty acid component may consist of or be entirely composed of the palmitic, acid compound, thereby containing no other ingredients.

In some embodiments, the saturated fatty acid may include a stearic acid compound. The stearic acid compound is not limited by this disclosure, and may include conjugated stearic acid, unconjugated stearic acid, free stearic acid, stearic acid derivatives, and/or the like. Stearic acid, also known as octadecanoic acid, has a chemical formula of CH₃(CH₂)₁₆CO₂H. Specific examples of stearic acid derivatives may include stearic acid esters, stearic acid amides, stearic acid salts, stearic acid carbonates, stearic acid carbamates, stearic acid imides, stearic acid anhydrides, and/or the like. Because stearic acid in large amounts may hinder the milk production capacity of the mammary gland, the amount of stearic acid may be present in the fatty acid component in an amount of about 30% or less by weight of the fatty acid component. In particular embodiments, the stearic acid compound may include about 30% by weight of the fatty acid component, about 25% by weight of the fatty acid component, about 20% by weight of the fatly acid component, about 15% by weight of the fatty acid component, about 10% by weight of the fatty acid component, about 5% by weight of the fatty acid component, or any value or range between any two of these values (including endpoints).

In some embodiments, the fatty acid component may include an unsaturated fatty acid. Unsaturated fatty acid, as used herein, refers to any mono- or polyunsaturated fat, and includes unsaturated trans fatty acids. Unsaturated fatty acids contain at least one alkene bond and may contain two or more alkene groups in any position in the hydrocarbon chain. The unsaturation of the fatty acid may or may not be present as a conjugated system of double bonds. The type of unsaturated fatty acid present in the fatty acid component is not limited by this disclosure, and may include any type of unsaturated fatty acid now known or later discovered, including all derivatives thereof. For example, derivatives of an unsaturated fatty acid may include salts, esters, amides, anhydrides, alcohols, and/or the like, as previously described herein. In various embodiments, an amount of unsaturated fatty acid may be used in the fatty acid component to affect a desired quality of milk produced by the ruminant consuming the feed composition, as described in greater detail herein. Thus, in some embodiments, the fatty acid component may be substantially free of unsaturated fatty acids. As used herein with respect to unsaturated fatty acids, the term “substantially free” is understood to mean substantially no amount of unsaturated fatty acids or about 5% or less by weight of unsaturated fatty acids, including trace amounts of unsaturated fatty acids. Accordingly, the unsaturated fatty acid may be present in the fatty acid component in an amount of about 5% or less by weight of the fatty acid component, including about 5% or less by weight. about 4% or less by weight, about 3% or less by weight, about 2% or less by weight, about 1% or less by weight, about 0.5% or less by weight, about 0% by weight, or any value or range between any two of these values (including endpoints).

As described herein, the fatty acid component contains a high concentration of palmitic and/or stearic acids. Accordingly, it will be recognized that the fatty acid component may be predominately saturated fatty acids. Thus, the fatty acid component may contain little or no unsaturated fatty acids. Accordingly, the saturated fatty acid may be present in the fatty acid component in an amount of at least about 90% by weight of the fatty acid component. In particular embodiments, the saturated fatly acid may he present in the fatty acid component in an amount of about 90% by weight to about 100% by weight of the fatly acid component. Illustrative examples include, but are not limited to, saturated fatty acid in an amount of about 90% by weight, about 91% by weight, about 92% by weight, about 93% by weight, about 94% by weight, about 95% by weight, about 96% by weight, about 97% by weight, about 98% by weight, about 99% by weight, about 100% by weight of the fatty acid component, or any value or range between any two of these values (including endpoints).

In various embodiments, the coating layer HO may include at least one additional ingredient. For example, in some embodiments, the coating layer 110 may include at least one omega-3 fatty acid, at least one conjugated linoleic acid, at least one amino acid, at least one starch, at least one mineral, at least one vitamin, and/or the like. The at least one omega-3 fatty acid may generally be present in the coating layer HO such that, when it is consumed, it may lower elevated triglycerides in the ruminant's blood. In addition, omega-3 fatty acids may have other nutritional benefits when consumed by a ruminant. Illustrative omega-3 fatty acids may include (t-Linolenic acid (ALA), which may be derived from plant oils, eicosapentaenoic acid (EPA), which may be derived from marine oils, and docosahexaenoic acid (DHA), which is also derived from marine oils. Other illustrative sources of omega-3 EPA and DHA fatty acids may include, but are not limited to, fish oil, egg oil, squid oil, and krill oil. Other illustrative sources of omega-3 ALA fatty acids may include, but are not limited to, walnut seed, seabuckthom seed, chia seed, berry oil, clary sage seed oil, algal oil, flaxseed oil, Sacha Inchi oil, Echium oil, and hemp oil.

The at least one conjugated linoleic acid (CLA) may generally be present in the coating layer 110 such that, when it is consumed, it provides various health benefits to the ruminant. For example, in some embodiments, addition of the at least one CLA in the coating layer 110 may assist in increasing milk production and/or milk fat content, as described in greater detail herein. CLA may include a family of at least 28 isomers of linoleic acid commonly found in meat and dairy products from ruminants. In various embodiments, CLA may be a cis-fat or a trans-fat.

The at least one amino acid may generally be present in the coating layer 110 such that, when it is consumed, it provides a nutritional aid in various physiological processes in the ruminant, such as, for example, increasing muscle mass, providing energy, aiding in recovery, and/or the like. In some embodiments, the at least one amino acid may be obtained from an amino acid premix composition. In some embodiments, the at least one amino acid may be an essential amino acid, including any combination of leucine, lysine, histidine, valine, arginine, threonine, isoleucine, phenylalanine, methionine, and tryptophan, as well as any protected form or any derivative thereof. In some embodiments, the at least one amino acid may be a non-essential amino acid, including any combination of alanine, asparagine, aspartate, cysteine, glutamate, glutamine, glycine, proline, serine, and tyrosine, as well as any protected form or any derivative thereof. The at least one amino acid, any protected form thereof and/or any derivative thereof may also include amino acids, protected forms, and derivatives of both non-essential and essential amino acids. The at least one amino acid may further be a common amino acid or an uncommon amino acid, as well as any protected form or derivative thereof. Common amino acids are generally recognized as a class of amino acids most commonly found in nature, which includes glycine, alanine, valine, leucine, isoleucine, phenylalanine, tyrosine, tryptophan, methionine, cysteine, serine, threonine, arginine, lysine, histidine, proline, glutamate, aspartate, glutamine, and asparagine. In contrast, uncommon amino acids include any other amino acid not listed above,

In various embodiments, the at least one starch may serve as a thickening and/or a stabilizing agent in the coating layer 105. Specific examples of starches may include starch hydrolysate, hydroxyalkylated starch, starch ester, cross-linked starch, starch acetate, starch octenyl succinate, and/or the like.

Similar to the at least one mineral that may be present in the core 105, the at least one mineral present in the coating layer 110 may be any mineral that is a generally recognized as safe (GRAS) mineral or a combination of such minerals. The mineral may further be obtained front any mineral source that provides a bioavailable mineral. In some embodiments, the mineral may be one or more of calcium, sodium, magnesium, potassium, phosphorous, zinc, selenium, manganese, iron, cobalt, copper, iodine, molybdenum, and/or the like. In some embodiments, the mineral may be selected from one or more of a sodium salt, a calcium salt, a magnesium salt, a cobalt salt, a manganese salt, a potassium salt, an iron salt, a zinc salt, copper sulfate, copper oxide, selenium yeast, a chelated mineral, and/or the like. Illustrative sodium salts include, but are not limited to, monosodium phosphate, sodium acetate, sodium chloride, sodium bicarbonate, disodium phosphate, sodium iodate, sodium iodide, sodium tripolyphosphate, sodium sulfate, sodium selenite, and/or the like. Illustrative calcium salts include, but are not limited to, calcium acetate, calcium carbonate, calcium chloride, calcium gluconate, calcium hydroxide, calcium iodate, calcium iodobehenate, calcium oxide, anhydrous calcium sulfate, calcium sulfate dehydrate, dicalcium phosphate, monocalcium phosphate, tricalcium phosphate, and/or the like. Illustrative magnesium salts include, but are not limited to, magnesium acetate, magnesium carbonate, magnesium oxide, magnesium sulfate, and/or the like. Illustrative cobalt salts include, but are not limited to, cobalt acetate, cobalt carbonate, cobalt chloride, cobalt oxide, cobalt sulfate, and/or the like. Illustrative manganese salts include, but are not limited to, manganese carbonate, manganese chloride, manganese citrate, manganese gluconate, manganese orthophosphate, manganese oxide, manganese phosphate, manganese sulfate, and/or the like. Illustrative potassium salts include, but are not limited to, potassium acetate, potassium bicarbonate, potassium carbonate, potassium chloride, potassium iodate, potassium iodide, potassium sulfate, and/or the like. Illustrative iron salts include, but are not limited to, iron ammonium citrate, iron carbonate, iron chloride, iron gluconate, iron oxide, iron phosphate, iron pyrophosphate, iron sulfate, reduced iron, and/or the like. Illustrative zinc salts include, but are not limited to, zinc acetate, zinc carbonate, zinc chloride, zinc oxide, zinc sulfate, and/or the like.

Similar to the vitamin that may be present in the core 105, the at least one vitamin present in the coating layer 110 may include, but is not limited to, vitamin A, vitamin B, vitamin C, vitamin D, vitamin E, vitamin K, and/or the like, as well as any combination thereof. In some embodiments, a vitamin may include any vitamins from each particular vitamin group, including A vitamins, B vitamins, C vitamins, D vitamins, E vitamins, K vitamins, and/or the like. Specific examples of B vitamins include thiamine, riboflavin, niacin, pantothenic acid, pyridoxine, biotin, folic acid, cobalamin, and choline.

Similar to the camitine that may be present in the core 105, the coating layer 110 may also include camitine. In various embodiments, camitine may be included in the coating layer 110 to aid in the breakdown of fatty acids to generate metabolic energy in the ruminant. In some embodiments, camitine may be added to the coating layer 110 from a camitine premix composition.

In various embodiments, the coating layer 110 may include at least one emulsifier. The at least one emulsifier is not limited by this disclosure, and may generally be any composition that is capable of emulsifying the coating layer 110. In some embodiments, the emulsifier may be a nonionic emulsifier. Specific examples of nonionic emulsifiers may include ethoxylated fatty alcohols, ethoxylated alkylphenols, ethoxylated fatty acids, sorbitan derivatives, sucrose esters and derivatives, ethylene oxide-propylene oxide block copolymers, fluorinated alkyl polyoxyethylene ethanols, and/or any combination thereof. Other examples of emulsifiers may include lecithin, natural seed weed, natural seed gums, natural plant exudates, natural fruit extracts, animal skin and bone extracts, bio-synthetic gums, starches, fibers, sucrose esters, Tween, polyglycerol esters, sugar esters, castor oil, and ethoxylated castor oil, an ammonia solution, butoxyethanol, propylene glycol, ethylene glycol, ethylene glycol polymers, polyethylene, methoxypolyethylene glycol, and/or any combination thereof. Examples of natural seed weed may include carrageenan, alginates, agar, agarose, fucellan, and xanthan gum or a combination thereof. Examples of natural seed gums may include guar gum, locust bean gum, tara gum, tamarind gum, and psillium gum. Examples of natural plant exudates are gum Arabic, tragacanth, karaya, and ghatti. Natural fruit extracts are, for example, low and high methoxyl pectins. Animal skin and bone extracts are, for example, gelatin A, gelatin B, and hydrolyzed gelatin. Gum Arabic is a natural food additive obtained from certain varieties of acacia. It is generally tasteless and odorless, and may be used in commercial food processing to thicken, emulsify, and/or stabilize foods. Guar QUM is a gummy substance obtained from plants of the legume genera. Guar gum may also be used as a thickener and/or a stabilizer in commercial food processing. Xanthan gum is produced by fermentation of corn sugar, and may be used as a thickener, an emulsifier, and/or a stabilizer of foods. In particular embodiments, gum Arabic, guar gum, xanthan gum, and/or pectin may be used in combination as an emulsion stabilizer. Illustrative examples of bio-synthetic gums may include xanthan, curdian, and pullulan. Examples of starches may include natural starch, chemically modified starch, physically modified starch, and enzymatically modified starch. Castor oil may be effective as an emulsifier because of its ability to render oil soluble in water.

In various embodiments, the emulsifier may have a hydrophilic-lipophilic balance (HLB) of about 5 to about 14. In particular embodiments, the HLB of the emulsifier may be about 5, about 6, about 7, about 8, about 9, about 10, about 11, about 12, about 13, about 14, or any value or range between any two of these values (including endpoints).

In various embodiments, the emulsifier may be present in the feed particle 100 in an amount of about 0.01% by weight to about 1.0% by weight, about 0.02% by weight to about 0.2% by weight, or about 0.02% by weight to about 0.05% by weight of the feed particle. In particular embodiments, the emulsifier may be present in the feed particle 100 in an amount of about 0.01% by weight, about 0.02% by weight, about 0.03% by weight, about 0.04% by weight, about 0.05% by weight, about 0.1% by weight, about 0.2% by weight, about 0.25% by weight, about 0.3% by weight, about 0.5% by weight, about 0.6% by weight, about 0.75% by weight, about 1.0% by weight, about 1.25% by weight, about 1.5% by weight, about 1.75% by weight, about 2.0% by weight, or any value or range between any two of these values (including endpoints).

In some embodiments, the emulsifier may be present in the feed particle 100 relative to the amount of fatty acid present in the feed particle. Thus, in some embodiments, the emulsifier may be present in the feed particle 100 in an amount of about 0.2% to about 2.0% by the weight of the saturated fatty acid in the feed particle. In some embodiments, the emulsifier may be present in the feed particle 100 by the weight of the saturated fatty acid in an amount of about 0.5% to about 1.5%. In further embodiments, the emulsifier may be present in the teed particle 100 in an amount of about 0.8% to about 1.2% by the weight of the saturated fatty acid. Specific illustrative amounts may include, but are not limited to, about 0.2%, about 0.3%, about 0.4%, about 0.5%, about 1%, about 1.5%, about 2% by weight of the saturated fatty acid, or any value or range between any two of these values (including endpoints).

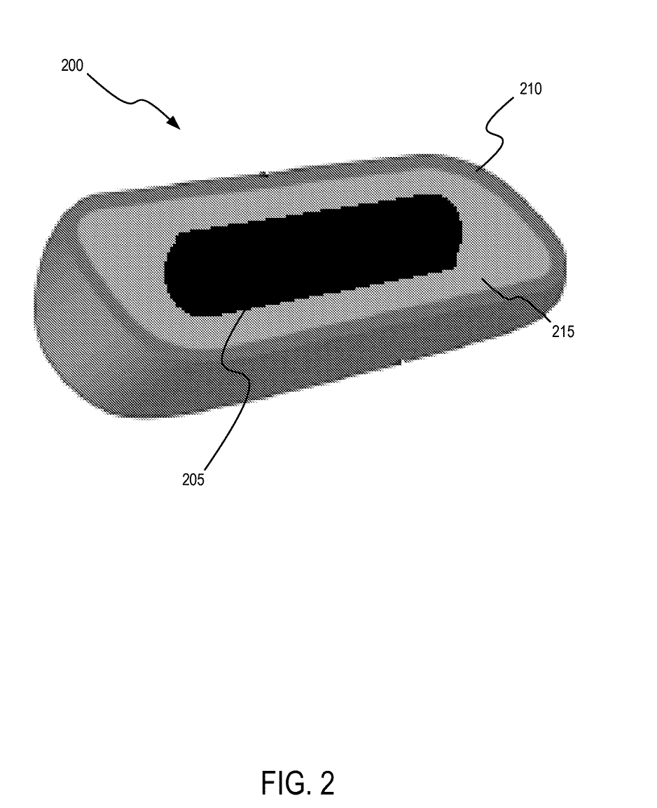

FIG. 2 depicts another illustrative feed particle, generally designated 200, according to an embodiment. The feed particle 200 may generally include a core 205, a first coating layer 210, and a second coating layer 215. The core 205 may generally be identical to the core 105 described herein with respect to FIG. 1. Thus, the core 205 may include any of the ingredients described herein, including at least one carbohydrate component and at least one protein component. Similarly, the first coating layer 210 may generally be identical to the coating layer 110 described herein with respect to FIG. 1. Thus, the first coating layer 210 may include any of the ingredients described herein, including the saturated fatty acid. Similar to the embodiments presented herein with respect to FIG. 1, the first coating layer 210 may also be disposed around at least a portion of the core 205.

As shown in FIG. 2, the second coating layer 215 may generally be disposed between the first coating layer 210 and the core 205. Similar to the first coating layer 210, the second coating layer 215 may cover at least a portion of the core 205. Thus, the feed particle 200 may generally be arranged such that the second coating layer 215 is disposed around at least a portion of the core. For example, the second coating layer 215 may be disposed around a portion of the surface area of the core 205, such as about 1%, about 10%, about 20%, about 30%, about 40%, about 50%, about 60%, about 70%, about 80%, about 90%, about 100% of the surface area of the core, or any value or range between any two of these values (including endpoints). In some embodiments, the second coating layer 215 may completely encapsulate the core 205. In some embodiments, the second coating layer 215 may be intermittently dispersed about the surface area of the core 205. In some embodiments, the feed particle 200 may be arranged such that the second coating layer 215 covers 100% of the surface area of the core 205 and the first coating layer 210 covers 100% of the surface area of the second coating layer. Those having ordinary skill in the art will recognize other configurations of the first coating layer 210 and the second coating layer 215 without departing from the scope of the present disclosure.

In various embodiments, the fatty acid may generally only be present in the first coating layer 210, whereas the additional ingredients described herein may be present in either or both of the first coating layer and the second coating layer 215. Thus, the second coating layer 215 may serve as an additional coating for the core 205 to substitute or supplement ingredients included in the first coating layer 210.

Similar to the first coating layer 210, the second coating layer 215 may include at least one omega-3 fatty acid, at least one conjugated linoleic acid, at least one amino acid, at least one starch, at least one mineral, at least one vitamin, and/or the like. The at least one omega-3 fatty acid may generally be present in the second coating layer 215 such that, when it is consumed, it may lower elevated triglycerides in the ruminant's blood. In addition, omega-3 fatty acids may have other nutritional benefits when consumed by a ruminant. Illustrative omega-3 fatty acids may include ALA, which may be derived from plant oils, EPA, which may be derived from marine oils, and DHA, which is also derived from marine oils. Other illustrative sources of omega-3 EPA and DHA fatty acids may include, but are not limited to, fish oil, egg oil, squid oil, and krill oil. Other illustrative sources of omega-3 ALA fatty acids may include, but are not limited to, walnut seed, seabuckthom seed, chia seed, berry oil, clary sage seed oil, algal oil, flaxseed oil, Sacha Inchi oil, Echium oil, and hemp oil.

The at least one CLA may generally be present in the second coating layer 215 such that, when it is consumed, it provides various health benefits to the ruminant. For example, in some embodiments, addition of the at least one CLA in the second coating layer 215 may assist in increasing milk production and/or milk fat content, as described in greater detail herein. CLA may include a family of at least 28 isomers of linoleic acid commonly found in meat and dairy products from ruminants. In various embodiments, CLA may be a cis-fat or a trans-fat.

The at least one amino acid may generally be present in the second coating layer 215 such that, when it is consumed, it provides a nutritional aid in various physiological processes in the ruminant, such as, for example, increasing muscle mass, providing energy, aiding in recovery, and/or the like. In some embodiments, the at least one amino acid may be obtained from an amino acid premix composition. In some embodiments, the at least one amino acid may be an essential amino acid, including any combination of leucine, lysine, histidine, valine, arginine, threonine, isoleucine, phenylalanine, methionine, and tryptophan, as well as any protected form or any derivative thereof. In some embodiments, the at least one amino acid may be a non-essential amino acid, including any combination of alanine, asparagine, aspartate,cysteine, glutamate, glutamine, glycine, proline, serine, and tyrosine, as well as any protected form or any derivative thereof. The at least one amino acid, any protected form thereof, and/or any derivative thereof may also include amino acids, protected forms, and derivatives of both non-essential and essential amino acids. The at least one amino acid may further be a common amino acid or an uncommon amino acid, as well as any protected form or derivative thereof. Common amino acids are generally recognized as a class of amino acids most commonly found in nature, which includes glycine, alanine, valine, leucine, isoleucine, phenylalanine, tyrosine, tryptophan, methionine, cysteine, serine, threonine, arginine, lysine, histidine, proline, glutamate, aspartate, glutamine, and asparagine. In contrast, uncommon amino acids include any other amino acid not listed above.

In various embodiments, the at least one starch may serve as a thickening and/or a stabilizing agent in the second coating layer 215. Specific examples of starches may include starch hydrolysate, hydroxyalkylated starch, starch ester, cross-linked starch, starch acetate, starch octenyl succinate, and/or the like.

Similar to the at least one mineral that may be present in the core 205 and/or the first coating layer 210, the at least one mineral present in the second coating layer 215 may be any mineral that is a GRAS mineral or a combination of such minerals. The mineral may further be obtained from any mineral source that provides a bioavailahle mineral. In some embodiments, the mineral may be one or more of calcium, sodium, magnesium, potassium, phosphorous, zinc, selenium, manganese, iron, cobalt, copper, iodine, molybdenum, and/or the like. In some embodiments, the mineral may be selected from one or more of a sodium salt, a calcium salt, a magnesium salt, a cobalt salt, a manganese salt, a potassium salt, an iron salt, a zinc salt, copper sulfate, copper oxide, selenium yeast, a chelated mineral, and/or the like. Illustrative sodium salts include, but are not limited to, monosodium phosphate, sodium acetate, sodium chloride, sodium bicarbonate, disodium phosphate, sodium iodate, sodium iodide, sodium tripolyphosphate, sodium sulfate, sodium selenite, and/or the like. Illustrative calcium salts include, but are not limited to, calcium acetate, calcium carbonate, calcium chloride, calcium gluconate, calcium hydroxide, calcium iodate, calcium iodobehenate, calcium oxide, anhydrous calcium sulfate, calcium sulfate dehydrate, dicalcium phosphate, monocalcium phosphate, tricalcium phosphate, and/or the like. Illustrative magnesium salts include, but are not limited to, magnesium acetate, magnesium carbonate, magnesium oxide, magnesium sulfate, and/or the like. Illustrative cobalt salts include, but are not limited to, cobalt acetate, cobalt carbonate, cobalt chloride, cobalt oxide, cobalt sulfate, and/or the like. Illustrative manganese salts include, but are not limited to, manganese carbonate, manganese chloride, manganese citrate, manganese gluconate, manganese orthophosphate, manganese oxide, manganese phosphate, manganese sulfate, and/or the like. Illustrative potassium salts include, but are not limited to, potassium acetate, potassium bicarbonate, potassium carbonate, potassium chloride, potassium iodate, potassium iodide, potassium sulfate, and/or the like. Illustrative iron salts include, hut are not limited to, iron ammonium citrate, iron carbonate, iron chloride, iron gluconate, iron oxide, iron phosphate, iron pyrophosphate, iron sulfate, reduced iron, and/or the like. Illustrative zinc salts include, but are not limited to, zinc acetate, zinc carbonate, zinc chloride, zinc oxide, zinc sulfate, and/or the like.

Similar to the vitamin that may be present in the core 205 and/or the first coating layer 210, the at least one vitamin present in the second coating layer 215 may include, but is not limited to, vitamin A, vitamin B, vitamin C, vitamin D, vitamin E, vitamin K, and/or the like, as well as any combination thereof. In some embodiments, a vitamin may include any vitamins from each particular vitamin group, including A vitamins, B vitamins, C vitamins, D vitamins, E vitamins, K vitamins, and/or the like. Specific examples of B vitamins include thiamine, riboflavin, niacin, pantothenic acid, pyridoxine, biotin, folic acid, cobalamin, and choline.

Similar to the camitine that may be present in the core 205 and/or the first coating layer 210, the second coating layer 215 may also include camitine. In various embodiments, camitine may be included in the second coating layer 215 to aid in the breakdown of fatty acids to generate metabolic energy in the ruminant. In some embodiments, carnitine may be added to the second coating layer 215 from a carnitine premix composition.

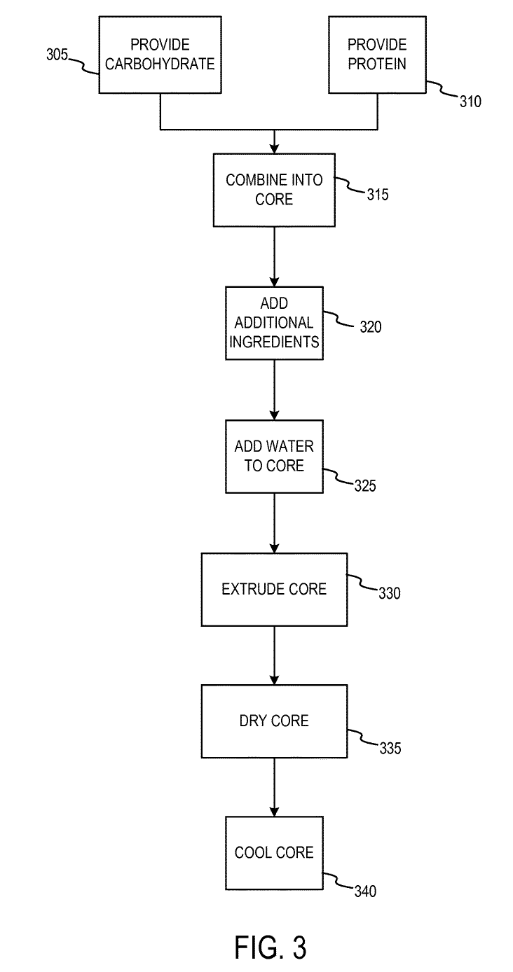

FIG. 3 depicts a flow diagram of an illustrative method of preparing a core portion of a feed composition for a ruminant. In some embodiments, the method of preparing the feed composition may include preparing a ruminant teed composition, particularly ruminant feed compositions described herein. In various embodiments, the feed composition may be formulated in a manner such that when it is consumed by the ruminant, the feed composition improves particular qualities in the milk produced by the ruminant and/or increases an amount of milk produced by the ruminant, as described in greater detail herein. In particular embodiments, the feed composition may be substantially a solid feed composition, including, but not limited to, a capsule, a tablet, a pellet, a granular material, or the like, as described in greater detail herein.

In various embodiments, the components described herein may generally be combined in any order and/or any combination, and are not limited by the order described herein. In some embodiments, a feed composition may be prepared by providing 305 at least one carbohydrate component, providing 310 at least one protein component, and combining 315 the at least one carbohydrate component and the at least one protein component to form a core material. In some embodiments, combining 315 the at least one carbohydrate component and the at least one protein component may include mixing the at least one carbohydrate component and the at least one protein component to form a mixture. In some embodiments, additional ingredients may also be added 320 to the core, particularly the additional ingredients described in greater detail herein.

In various embodiments, providing 305 the at least one carbohydrate component may include grinding the at least one carbohydrate component. Similarly, in various embodiments, providing 310 the at least one protein component may include grinding the at least one protein component. In some embodiments, other portions of the core material may be ground in addition to the at least one carbohydrate component and/or the at least one protein component. Grinding may provide various benefits, such as improving certain characteristics of the at least one carbohydrate component, the at least one protein component, and/or the core material formed therefrom. For instance, even and fine particle size may improve the mixing of different ingredients. According to certain embodiments, grinding may be configured to decrease a particle size of certain components of the core material. For example, grinding may be configured to increase the surface area open for enzymes in the gastrointestinal tract, which may improve the digestibility of nutrients. In another example, grinding may be configured to increase the palatability of the feed composition.

Grinding may be performed by various grinding devices known to those having ordinary skill in the art, such as a hammer mill, a roller mill, a disk mill, or the like. The core material and/or portions thereof (such as the carbohydrate component or the protein component) may be ground to various sizes. Size can be measured in any number of ways, such as particle size (for instance, measured in millimeters), mesh sizes, surface areas, or the like. According to some embodiments, the core material and/or portions thereof may be ground to an average particle size of about 0.05 mm to about 3 ram. In some embodiments, the average particle size may be about 0.1 mm to about 3 mm. More particularly, the core material may be ground to produce a granular material having an average particle size of about 0.05 mm, about 0.1 mm, about 0.2 mm, about 0.5 mm, about 1 mm, about 2 min, about 3 mm, or any value or range between any two of these values. In some embodiments, the core material may be ground so that about 20% to about 50% of the ground core material is retained by a mesh having openings with a size of about 3 mm and about 70% to about 90% of the ground core material is retained by a mesh having openings with a size of about 1 mm. In some embodiments, the core material and/or various portions thereof may have a varying distribution of particle sizes based upon the ingredients. For example, in embodiments where the at least one carbohydrate component is wheat, the particle size may be distributed so that about 95% of the ground wheat is retained by a mesh having openings with a size of about 0.0625 mm and about 65% of the ground wheat is retained by a mesh having openings with a size of about I mm. In another example, such as embodiments where the at least one protein component is a soybean, the particle size may be distributed so that about 95% of the ground soybean is retained by a mesh having openings with a size of about 0.0625 mm and about 60% of the ground soybean is retained by a mesh having openings with a size of about 1 mm. The varying mesh sizes for each ingredient may be independent of mesh sizes for other ingredients. In some embodiments, the granular material or powder obtained from grinding may be used in subsequent processes such as molding, extrusion, and/or tableting, as described in greater detail herein.

Granular material, as used herein, refers to a conglomeration of discrete solid, macroscopic particles and is meant to encompass a wide variety of material types, shapes, and sizes. Granular material includes powders as a subset, but also includes groups of larger particles. Granular material may be particularly well-suited for tableting and encapsulation, as well as molding.

In various embodiments, water may be added 325 to the core material, such as, for example, by combining water with the core material. Water may be added 325 in liquid form or in vapor form (for example, steam). In some embodiments, water may generally be added 325 to obtain a suitable mass of material for extruding 330 the core.

In various embodiments, the core material may be extruded 330 by any method of extrusion now known or later developed to form the core. Thus, for example, the core may be formed by forcing an amount of the core material through a die such that the resulting extruded core has a desired shape and size. The shape and size of the core material is not limited by this disclosure, and may generally be any shape and/or size that is suitable for ruminant consumption. For example, a ruminant may prefer to eat a feed composition having a particular shape and/or size. In another example, a feed composition having a particular shape and/or size may be better suited for optimum ruminant digestion and/or the like.

In various embodiments, the core material may be dried 335 and/or cooled 340 before additional processes, such as applying a coating material, are performed. Drying 335 may generally be performed to remove any excess water or other undesired materials, as well as to provide a material that is suitable for coating and/or the like. Drying 335 may be completed by any method now known or later developed, such as, for example, placing the core in an oven and heating the core until a sufficient amount of water has evaporated.

Cooling 340 may be completed via any method of cooling, and may generally be completed to ensure the core hardens. In some embodiments, the core may be cooled 340 to a particular temperature. The temperature is not limited by this disclosure, and may generally be any temperature. Illustrative temperatures may be about 20° C. to about 35° C., including about 20° C., about 21° C., about 22° C., about 23° C., about 24° C. about 25° C., about 26° C., about 27° C., about 28° C., about 29° C., about 30° C., about 31° C., about 32° C., about 33° C., about 34° C., about 35° C., or any value or range between any two of these values (including endpoints).

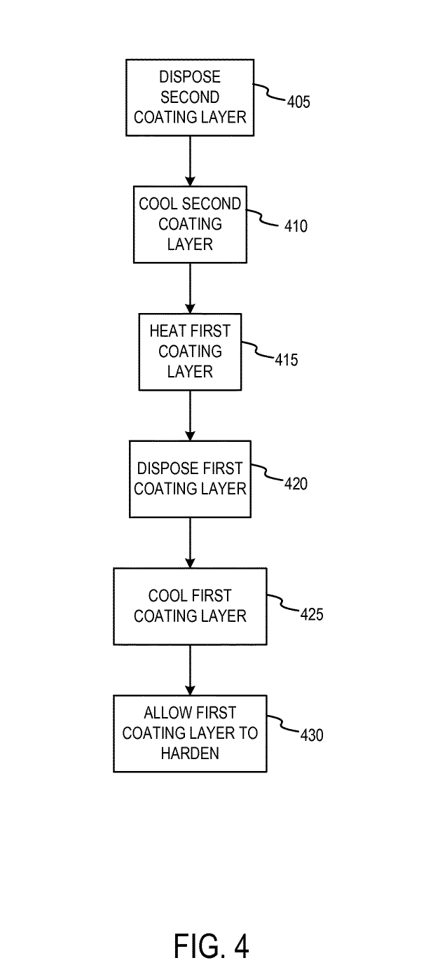

FIG. 4 depicts an illustrative method of applying at least one coating layer to the core material. In embodiments where two coating layers are to be applied, such as embodiments described herein with respect to FIG. 2, the second coating layer may be disposed 4005 on the core prior to the first coating layer to ensure the second coating later is located between the first coating layer and the core, as described in greater detail herein. The second coating layer may be disposed 405 on the core by any applicable method, including, for example, heating the second coating material such that the second coating layer is in a liquid form and placing the core into the liquid second coating layer, spraying the second coating material on the core, depositing via physical vapor deposition (PVD), and/or the like.

In embodiments where disposing 405 the second coating layer includes heating the second coating layer, cooling 410 the second coating layer may be completed once the layer is disposed on the core. Cooling 410 is not limited by this disclosure, and may include, for example, allowing the second coating layer o cool (passive cooling) or actively cooling the second coating layer.

In various embodiments, the first coating layer may be heated 415. Heating 415 the first coating layer may generally be completed to obtain a melted first coating layer such as a liquid and/or a semisolid first coating layer. The first coating layer may generally be heated 415 to any temperature. For example, the first coating layer may be heated 415 to a temperature that is greater than or equal to the melting point of the fatty acid component of the first coating layer. Thus, the fatty acid component of the first coating layer may be heated such that the fatty acid component reaches a liquid or semisolid state. One illustrative temperature may be greater than or equal to about 40° C. Another illustrative temperature may be less than or equal to about 80° C. Another illustrative temperature may be about 40° C. to about 80° C. Other illustrative temperatures may include about 40° C., about 45° C., about 50° C., about 55° C., about 60° C., about 65° C., about 70° C., about 75° C., about 80° C., or any value or range between any two of these values (including endpoints).

As an alternative to heating 415, in some embodiments, the first coating layer may be dispersed in water to obtain a liquid suspension. For example, the fatty acid component and the water may be provided in a volume/volume ratio from about 1:20 to about 1:1, from about 1:15 to about 2:1, from about 1:10 to about 3:1, including about 1:20, about 1:15, about 1:10, about 1:5, about 1:3, about 1:2, about 1:1, about 2:1, about 3:1, or any value or range between any two of these values (including endpoints).

Similar to the second coating layer, the first coating layer may be disposed 420 on the core and/or the second coating layer by any method now known or later developed. For example, disposing 420 may include spraying, sputtering, depositing via PVD, and/or the like. In sonic embodiments, a liquid first coating layer may be disposed 420 on the core and/or the second coating layer. In other embodiments, an emulsion containing the first coating layer may be disposed 420 on the core and/or the second coating layer.

In various embodiments, the first coating layer may be cooled 425. Cooling 425 may include cooling the resulting feed composition (including the core, the first coating layer and/or the second coating layer) to a suitable temperature. In some embodiments, the suitable temperature may be less than or equal to a crystallization temperature of the fatty acid component. Thus, in some embodiments, the suitable temperature may be about 0° C. to about 80° C. including, but not limited to, about 0° C., about 10° C., about 20° C., about 30° C., about 40° C., about 50° C., about 60° C., about 70° C., about 80° C., or any value or range between any two of these values (including endpoints). In some embodiments, the suitable temperature may be about 42° C. Cooling 425 may include active cooling or passive cooling.

In various embodiments, the first coating layer may be allowed 430 to harden. In some embodiments, cooling 425 the first coating layer may cause the first coating layer to harden. In other embodiments, exposing the first coating layer to air may cause the first coating layer to harden. In some embodiments, allowing 430 the first coating layer to harden may include passively allowing the first coating layer to harden.

In various embodiments, a method of increasing milk fat content in ruminants may include providing at least the feed composition as described herein to the ruminant for ingestion. In some embodiments, the feed composition may be provided to the ruminant in an amount such that the ruminant receives at least about 10 grams of fatty acid per kilogram of milk produced by the ruminant each day. The amount may be based on the previous day's milk production by the ruminant, an average day based on the previous week's milk production by the ruminant, an average day based on the previous month's milk production by the ruminant, an average production of milk by the ruminant when not provided with the feed composition, and/or the like. In some embodiments, the ruminant may be provided with about 0.5 kg to about 1.5 kg of the feed composition each day, including about 0.5 kg, about 0.75 kg, about 1.0 kg, about 1.25 kg, about 1.5 kg, or any value or range between any two of these values (including endpoints). In some embodiments, the ruminant may be provided with additional amounts of the feed composition to make up for portions of the feed composition that are not consumed by the ruminant, such as amounts that are spilled by the ruminant when consuming the feed composition, amounts that are consumed by other animals, and/or the like.

In some embodiments, consumption of the feed composition by the ruminant may result in increased milk production and/or increased fat content of the milk produced. These increases may generally be relative to a similar ruminant that does not receive the feed composition, an average of similar ruminants not receiving the feed composition, an average of the milk production quantity and fat content of the same ruminant when not provided the feed composition, and/or the like. In particular embodiments, the milk production may increase by an amount of at least about 1%. In some embodiments, the milk production may increase by an amount of about 1% to about 10%, including about 1%, about 2%, about 3%, about 4%, about 5%, about 6%, about 7%, about 8%, about 9%, about 10%, or any value or range between any two of these values. In particular embodiments, the milk fat content may increase by an amount of at least about 10%. In some embodiments, the milk fat content may increase by an amount of about 10% to about 15%, including about 10%, about 11%, about 12%, about 13%, about 14%, about 15%, or any value or range between any two of these values.

### EXAMPLES

### Example 1

### Making a Feed Composition

A feed composition to be fed to ruminants is made using a process of making a core material and coating the core material with a first coating layer and a second coating layer. The second coating layer will encapsulate the entire core, and the first coating layer will encapsulate the entire second coating layer (and thus the core as well). A cross section will first pass through the first coating layer, then the second coating layer, then the core.

Preparing the core material will include combining a carbohydrate component, a protein component, vitamin A, vitamin C, vitamin D, thiamine, niacin, folic acid, and various minerals containing ions of calcium, sodium, magnesium, and potassium. The carbohydrate component will be a mixture of sugar beet pulp, rapeseed meal, wheat bran, starch, cellulose, roughages, and grass meal. The protein component will be a mixture that is obtained from soybeans, palm oil, fish meal, and brewer's yeast. The core material will be ground using a commercial grinder such that it has an average particle size of about 5 mm. Water will be added to the core material so that it can be extruded through a die press to form the core. The extruded core material will be placed into a convection oven at 65° C. to dry until the water content is less than about 10% of the core material.

The second coating layer will be a mixture of omega-3 fatty acid, leucine, valine, and various minerals containing ions of calcium, magnesium, potassium, and iron. The second coating layer will be generally aqueous such that it can be sprayed onto the core. After spraying, the second coating layer will be allowed to dry and harden over the core.

The first coating layer will be an emulsion of saturated fatty acid and water. Thus, the first coating layer will contain substantially no unsaturated trans-fatty acids. The saturated fatty acid will be about 98% by weight palmitic acid and about 2% by weight stearic acid. The first coating layer will be heated to a temperature of about 64° C. so that it melts and can be sprayed on the second coating layer. The resulting feed composition will be cooled such that the first coating layer crystallizes and hardens over the second coating layer.

The resulting feed composition will be packaged into bulk shipping containers that can be stored and/or shipped to distributors. The distributors will divide the bulk amounts into suitable amounts that are sold to end users such as dairy farmers and/or the like. Once the end user receives the feed composition, he/she may provide the teed composition to one or more ruminants.

### Example 2

### Feeding a Dairy Cow

A feed composition as described in Example 1 is provided to a dairy cow for consumption each day. A dairy cow that has a normal (untreated) average daily production of 30 kg milk is provided with the feed composition each day for a month to increase the milk fat and the quantity of the milk produced. At the end of the month, it is observed that she produces 10% more milk than she did previously and the milk that she produces contains 10% more milk fat content than the milk she produced previously.

### Example 3

### Providing to a Large Group of Cows

The feed composition as described in Example 1 is provided to a large group of cows on a commercial dairy farm to confirm its effectiveness in increasing milk production and increasing milk fat content. A group of 200 dairy cows from the commercial dairy farm are selected at random to provide a wide variety of variation in various characteristics, such as breed, weight, age of the cow, and the like. The 200 cows are divided into two groups: a sample cow group of 100 cows and a control cow group of 100 cows. Each day, the sample cow group is provided with the feed composition ad libitum. The control cow group is fed a standard, commercially-available total mixed ration (TMR) feed. The 200 cows are monitored for the amount of feed and/or feed composition consumed, changes in weight, an amount of milk the cow produces each day and the composition of the milk produced by the cow each day. Monitoring continues for a period of 90 days. A comparison of the two groups of cows over this period of time shows a statistically significant increase in the amount of milk that is produced and the fat content in the milk from the group that consumed the feed composition over the control group that received the commercially-available TMR feed.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A., B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A feed composition comprising:
a core comprising at least one carbohydrate component and at least one protein component; and
a first coating layer disposed around at least a portion of the core, wherein the first coating layer comprises a fatty acid component comprising at least about 90% saturated fatty acid by weight.

2. The feed composition of claim 1, wherein the first coating layer consists essentially of the fatty acid component.

3. (canceled)

4. The feed composition of claim 1, further comprising a second coating layer disposed between the first coating layer and the core, wherein the second coating layer covers at least a portion of the core.

5. (canceled)

6. The feed composition of claim 4, wherein the second coating layer comprises at least one of an omega-3 fatty acid, conjugated linoleic acid, an amino acid, a starch, a mineral, or a vitamin.

7. The feed composition of claim 4, wherein the second coating layer comprises at least one amino acid comprising leucine, lysine, histidine, valine, arginine, threonine, isoleucine, phenylalanine, methionine, tryptophan, or any derivative thereof.

8. The feed composition of claim 4, wherein the second coating layer comprises at least one mineral comprising an ion of calcium, sodium, magnesium, potassium, phosphorus, zinc, selenium, manganese, iron, cobalt, copper, iodine, molybdenum, or any combination thereof.

9. The feed composition of claim 4, wherein the second coating layer comprises at least one vitamin comprising vitamin A, vitamin C, vitamin D, vitamin E, vitamin K, thiamine, riboflavin, niacin, pantothenic acid, pyridoxine, biotin, folic acid, cobalamin, or choline.

10. The feed composition of claim 4, wherein the second coating layer comprises carnitine.

11. The feed composition of claim 1, wherein the first coating layer further comprises at least one of an omega-3 fatty acid, conjugated linoleic acid, an amino acid, a starch, a mineral, or a vitamin.

12. The feed composition of claim 1, wherein the first coating layer further comprises at least one amino acid comprising leucine, lysine, histidine, valine, arginine, threonine, isoleucine, phenylalanine, methionine, tryptophan, or any derivative thereof.

13. The feed composition of claim 1, wherein the first coating layer further comprises at least one mineral comprising an ion of calcium, sodium, magnesium, potassium, phosphorus, zinc, selenium, manganese, iron, cobalt, copper, iodine, molybdenum, or any combination thereof.

14. The feed composition of claim 1, wherein the first coating layer further comprises at least one vitamin comprising vitamin A, vitamin C, vitamin D, vitamin E, vitamin K, thiamine, riboflavin, niacin, pantothenic acid, pyridoxine, biotin, folic acid, cobalamin, or choline.

15. The feed composition of claim 1, wherein the first coating layer further comprises carnitine.

16. The feed composition of claim 1, wherein the first coating layer further comprises an emulsifier.

17. The feed composition of claim 16, wherein the emulsifier is a nonionic emulsifier.

18. (canceled)

19. The feed composition of claim 16, wherein the emulsifier comprises castor oil, an ammonia solution, butoxyethanol, propylene glycol, ethylene glycol, ethylene glycol polymers, polyethylene, methoxypolyethylene glycol, or any combination thereof.

20. The feed composition of claim 16, wherein the emulsifier is present in the feed composition in an amount of about 0.01% by weight to about 1.0% by weight of the feed composition.

21. (canceled)

22. The feed composition of claim 1, wherein the saturated fatty acid comprises a free palmitic acid compound.

23.-26. (canceled)

27. The feed composition of claim 1, wherein the saturated fatty acid comprises a palmitic acid compound in an amount of at least about 90% by weight of the fatty acid component.

28.-34. (canceled)

35. The feed composition of claim 1, wherein the fatty acid component is substantially free of unsaturated trans fatty acids.

36. The feed composition of claim 1, wherein the saturated fatty acid is present in the fatty acid component in an amount of at least about 95% by weight of the fatty acid component.

37.-38. (canceled)

39. The feed composition of claim 1, wherein the fatty acid component has a melting point of about 63° C. to about 65° C.

40. (canceled)

41. The feed composition of claim 1, wherein the at least one carbohydrate component comprises at least one of sugar beet pulp, molasses, bean meal, rapeseed meal, sugar cane, wheat bran, wheat middlings, wheat mill run, oat hulls, grain hulls, soya hulls, soybean hulls, peanut hulls, wood, brewery byproduct, forages, roughages, grass meal, hay meal, alfalfa meal, alfalfa, straw, algae, hay, sugar, starch, cellulose, hemicellulose, wheat, corn, oats, sorghum, millet, or barley.

42. The feed composition of claim 1, wherein the at least one protein component is obtained from a protein source, wherein the protein source is at least one of a soybean, a canola seed, cottonseed, or corn gluten meal, palm meal, meat meal, poultry meal, blood meal, feather meal, fish meal, wheat middlings, soybean hulls, corn byproducts, torula yeast, or brewer's yeast.

43. (canceled)

44. The feed composition of claim 1, wherein the core further comprises at least one of vitamin A, vitamin B, vitamin C, vitamin D, vitamin E, or vitamin K.

45. (canceled)

46. The feed composition of claim 1, wherein the core further comprises carnitine.

47. The feed composition of claim 1, wherein the core further comprises at least one mineral comprising an ion of calcium, sodium, magnesium, phosphorus, manganese, potassium, zinc, selenium, copper, iodine, iron, cobalt, molybdenum, selenite or any combination thereof.

48.-56. (canceled)

57. A method of preparing a feed composition, the method comprising:
combining at least one carbohydrate component and at least one protein component to obtain a core material; and disposing a first coating layer around at least a portion of the core material to obtain a coated core, wherein the first coating layer comprises a fatty acid component comprising at least about 90% saturated fatty acid by weight.

58.-61. (canceled)

62. The method of claim 57, further comprising extruding the core material prior to disposing the first coating layer.

63. The method of claim 62, further comprising combining water with the core material prior to extruding.

64.-66. (canceled)

67. The method of claim 57, wherein disposing the first coating layer comprises disposing a liquid first coating layer.

68. The method of claim 57, further comprising heating the first coating layer to obtain a melted first coating layer prior to disposing.

69. The method of claim 68, wherein heating comprises heating to a temperature greater than or equal to a melting point of the fatty acid component.

70. The method of claim 57, wherein disposing the first coating layer comprises spraying the first coating layer on at least a portion of the core material.

71. (canceled)

72. The method of claim 57, further comprising cooling the coated core to a temperature less than or equal to a crystallization temperature of the fatty acid component.

73. The method of claim 57, further comprising allowing the disposed first coating layer to harden.

74. The method of claim 57, further comprising disposing a second coating layer on at least a portion of the core material prior to disposing the first coating layer such that the second coating layer is disposed between the first coating layer and the core material.

75. A method of increasing milk fat content in ruminants, the method comprising:
providing a feed composition to a ruminant for ingestion, wherein the feed composition comprises:
a core comprising at least one carbohydrate component and at least one protein component; and
a first coating layer disposed on at least a portion of the core, wherein the first coating layer comprises a fatty acid component comprising at least about 90% saturated fatty acid by weight.

76. The method of claim 75, wherein providing the feed composition to the ruminant comprises providing about 0.5 kg to about 1.5 kg of feed composition to the ruminant daily.

77. The method of claim 75, wherein providing the feed composition to the ruminant comprises providing the feed composition to the ruminant at an amount such that the ruminant receives at least about 10 grams of fatty acid per kilogram of milk produced by the ruminant per day.

78. The method of claim 75, wherein providing the feed composition to the ruminant results in at least one of an increase in production of milk by the ruminant and an increase in a fat content in the milk produced by the ruminant, relative to a similar ruminant not provided the feed composition.

79. The method of claim 75, wherein providing the feed composition to the ruminant results in at least one of at least a 1% increase in production of milk by the ruminant and at least a 10% increase in a fat content in the milk produced by the ruminant, relative to a similar ruminant not provided the feed composition.
